(19) United States
(12) Patent Application Publication
(10) Pub. No.: US 2016/0063569 A1
(43) Pub. Date: Mar. 3, 2016

(54) OFFERS BASED ON PERSONAL METRICS

(71) Applicant: EBAY INC., San Jose, CA (US)

(72) Inventor: Megan Marie Williams, Santa Cruz, CA (US)

(21) Appl. No.: 14/474,621

(22) Filed: Sep. 2, 2014

(51) Int. Cl. G06Q 30/02

(52) U.S. Cl. CPC G06Q 30/0269; G06Q 30/0267

(57) ABSTRACT

Systems and methods for presenting offers based on personal metrics are provided. A user uses a mobile device or a wearable device with sensors to measure various personal metrics. The user uses the device to track activity, sleep, vital signs, and any other personal metrics. A service provider receives the personal metric data and other personal metric information. The service provider receives offers, such as coupons and voucher deals, for products and/or services from merchants. The service provider then presents offers to the user based on personal metric information of the user and other information, such as sleep patterns, hours slept, activity levels, distance traveled, measured heart rates, time of day, and/or location.

### BACKGROUND

1. Field of the Invention

The present invention generally relates to recommendations based on personal metrics, and particularly to presenting offers based on personal metric information.

2. Related Art

A user may present an offer displayed on a mobile device to a merchant instead of carrying and handing over a printed offer. Users of applications that present offers, such as coupons or voucher deals, on a mobile device are typically presented with general offers available to all. However, because the offers are not targeted, the user may be interested in only a few offers and not be interested in a majority of the offers. The user may have to sift through many offers to find an offer that the user is interested in, which may be inconvenient for the user. Thus, a need exists for systems and methods that provide more targeted offers.

### BRIEF DESCRIPTION OF THE FIGURES

FIG. 1 is a block diagram illustrating a system for presenting offers based on personal metrics according to an embodiment of the present disclosure;

FIG. 2 is a flowchart showing a method for presenting offers based on personal metrics according to an embodiment of the present disclosure;

FIG. 3 is a flowchart showing a method for presenting offers based on criteria for an offer according to an embodiment of the present disclosure;

FIG. 4 is an illustration of various screens presenting an offer on a mobile device according to an embodiment of the present disclosure; and

FIG. 5 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for presenting offers based on personal metrics, such as biometrics. A user may use a mobile device (e.g., a smartphone) or a wearable device (e.g., a wristband activity tracker) to measure, including track, monitor, and/or detect, various personal metrics. For example, the user may use the device to monitor sleep with metrics such as a sleep pattern, circadian rhythm, number of hours slept, and/or sleep quality. The user may use the device to track an activity with metrics such as a distance traveled (e.g., distance jogged), number of steps taken, and/or number of calories burned. The user may use the device to measure a heart rate, temperature, and/or blood pressure.

A service provider receives personal metric data and other personal metric information from the mobile device, the wearable device, and/or a personal metric information server that maintains information from the wearable device. The service provider selects offers for different products or services based on the personal metric information. The service provider then presents the offers on the mobile device of the user.

In an embodiment, offers are presented based on personal metric information relating to sleep. A device may have an accelerometer, heart rate sensor, thermometer, and/or location component for determining location. A user may use an application on the device to monitor sleep based on movement, heart rate, temperature, and/or location. A service provider receives sleep-related information, which may include raw data of sensor measurements and the data processed into information regarding sleep such as sleep patterns, circadian rhythms, number of hours slept, and/or sleep quality. The service provider then selects an offer to present to the user based on the sleep-related information. The service provider typically has criteria for the offers that are applied to each situation. In certain embodiments, where the criteria includes a number of hours slept, the service provider presents an offer for coffee if the user has slept less than a certain number of hours. In an example, the service provider presents an offer for free coffee if the user slept less than 3 hours, presents an offer for discounted coffee if the user slept between 3 and 5 hours, and presents no offer if the user slept more than 5 hours.

In certain embodiments, the offers based on sleep-related information are further based on preferences, habits, and/or history of a user. The service provider may determine a preference or a habit by direct user input or by inference based on the user's history. The user's history may comprise personal metric information over time, and trends and averages thereof. The user's history may further comprise a purchase history and/or previous coupon usage. In an example, the service provider determines that a user prefers teas or caffeinated sodas instead of coffee. The service provider then presents offers for tea, diet colas, or other caffeinated drinks instead of coffee. In another example, the service provider determines that a user has a habit of having coffee at a certain time period each day. The service provider then presents an offer for coffee during or before that time period. The offers may be based on a sleep history of the user during a certain time period (e.g., most recent month) comprising averages and trends of metrics such as hours slept and/or quality of sleep. In an example, 6 hours of detected sleep triggers a caffeine offer for a user who typically sleeps 8-10 hours, but the same 6 hours of sleep does not trigger a caffeine offer for another user who typically sleeps 5 hours.

In other embodiments, offers are presented based on personal metric information relating to activity/fitness. A device may have an accelerometer, gyroscope, altimeter, a pedometer, heart rate monitor, and/or location component. A user may use an application on the device to track movement, incline of path traveled, number of steps taken, heart rate, and/or distance traveled. A service provider receives activity information, which may include raw data of sensor measurements and the data processed into information regarding activity and/or exercise, such as calories burned and/or number of hours exercised. The service provider then selects an offer to present to the user based on the activity information. The offers may be used to reward the user and incentivize the user to exercise more. In an example, if the user burned a certain number of calories, the service provider presents an offer for a healthy treat, such as a fruit smoothie. In a further example, the service provider may determine that a healthy treat does not incentivize a certain user to exercise more and may increase the strength of the reward stimulus to a guilty pleasure, such as an ice cream cone. In another example, if the user jogged for a certain number of hours and the user's blood pressure is decreasing, the service provider may infer that the user is dehydrated and present an offer for a drink.

In certain embodiments, the offers based on activity information are further based on preferences, habits, and/or history of a user. For example, the service provider determines that a user prefers a specific type of product or brand based on the user's purchase history. The service provider may present offers for Powerade® for one user and Gatorade® for another user based on each user's preference. The offers may be based on the user's exercise history during a certain time period (e.g., most recent month) comprising averages and trends of metrics such as exercise sessions per week, hours exercised per exercise session, jog speed, etc. In an example, a detected 1 mile jog may trigger a reward offer for a user whose exercise typically comprises a brisk walk around the block, but the same 1 mile jog does not trigger a reward offer for another user who often runs 5 miles.

In further embodiments, if a user previously got excited when presented with an offer in a certain category, offers in the same and/or related categories may be presented to the user, thereby using the user's response as feedback for selecting offers. A device may have a heart rate sensor that measures the user's heart rate. A service provider receives measured heart rates and changes in heart rates. When the user's heart rate increases soon after the user is presented with an offer, the service provider can infer that the user is excited and/or interested in that offer. The service provider can then use the heart rate as feedback and adjust criteria for similar and/or related offers. In an example, if the user's heart rate increased in response to receiving a “buy one, get one free” offer at a certain merchant while the user is at a mall, the service provider may present a similar offer the next time the user is at the mall. If the offer had no effect on the user's heart rate and the user did not use the offer, the service provider can infer that the user is not interested and not present similar offers the next time the user is at the mall.

Various other personal metrics may be utilized in other embodiments by service providers to present offers to users. Further, various other user information, such as preferences, habits, and/or history of users, may be utilized by service providers to present offers. By targeting offers to users based on personal metric information and other user information, users are more likely to find the offers relevant and useful.

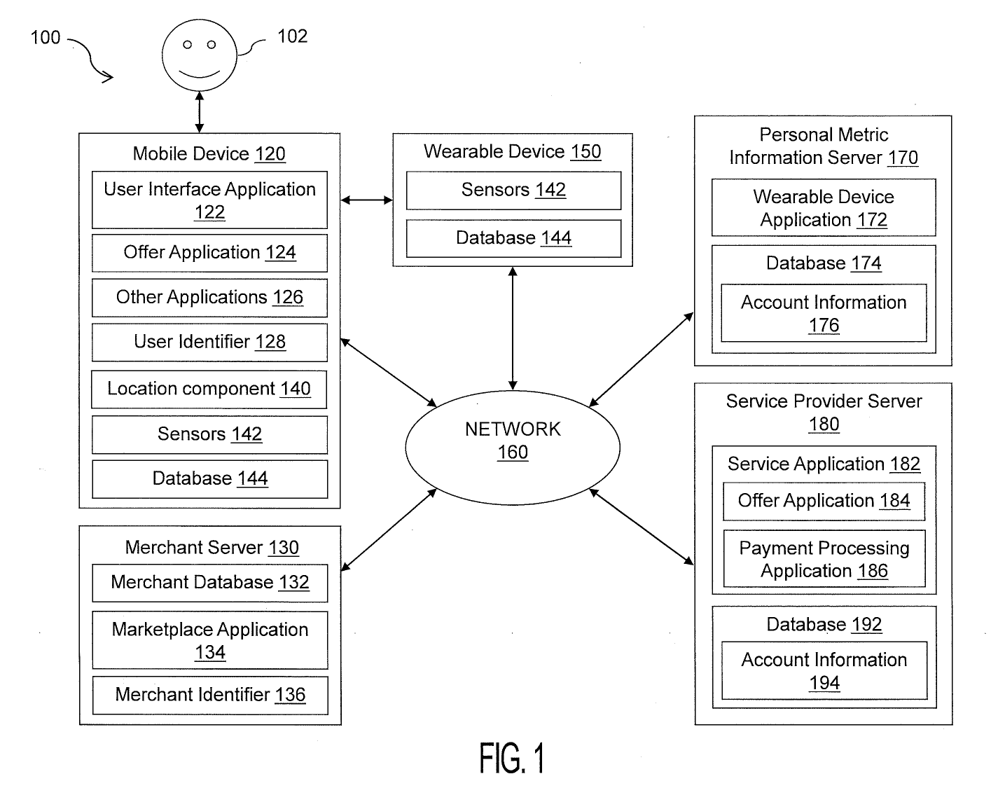

FIG. 1 shows one embodiment of a block diagram of a network-based system 100 that includes a mobile device 120 configured to present offers based on personal metrics according to an embodiment of the present disclosure. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, system 100 includes mobile device 120 (e.g., a smartphone), one or more merchant servers or devices 130 (e.g., network server devices), a wearable device 150 (e.g., wristband activity tracker, smart watch, etc.), a personal metric information server 170, and at least one service provider server or device 180 (e.g., network server device) in communication over a network 160. Network 160, in one embodiment, may be implemented as a single network or a combination of multiple networks. For example, in various embodiments, network 160 may include the Internet and/or one or more intranets, landline networks, wireless networks, and/or other appropriate types of communication networks. In another example, network 160 may comprise a wireless telecommunications network (e.g., cellular phone network) adapted to communicate with other communication networks, such as the Internet. As such, in various embodiments, mobile device 120 and service provider server or device 180 may be associated with a particular link (e.g., a link, such as a URL (Uniform Resource Locator) to an IP (Internet Protocol) address).

Mobile device 120, in one embodiment, is utilized by a user 102 to interact with service provider server 180 over network 160. For example, user 102 may transmit personal metric information to service provider server 180 via mobile device 120. In another example, user 102 may receive an offer, such as a coupon or a voucher deal, from service provider server 180 via mobile device 120. Mobile device 120, in various embodiments, may be implemented using any appropriate combination of hardware and/or software configured for wired and/or wireless communication over network 160. In various implementations, mobile device 120 may include at least one of a smartphone, wireless cellular phone, satellite phone, tablet (e.g., iPad™ from Apple®), laptop computer, notebook computer, hybrid/convertible computer, personal computer (PC), and/or other types of mobile computing devices.

Mobile device 120, in one embodiment, includes a user interface application 122, which may be utilized by user 102 to access applications, view personal metrics information, and/or transmit personal metrics information to service provider server 180 over network 160. In one aspect, user 102 may login to an account related to user 102 via user interface application 122.

In one implementation, user interface application 122 comprises a software program, such as a graphical user interface (GUI), executable by a processor that is configured to interface and communicate with service provider server 180 via network 160. In another implementation, user interface application 122 comprises a browser module that provides a network interface to browse information available over network 160. For example, user interface application 122 may be implemented, in part, as a web browser to view information available over network 160.

Mobile device 120, in various embodiments, includes an offer application 124. Offer application 124 may be developed by a service provider. Offer application 124 may be downloaded to mobile device 120 from an app store and/or from a service provider website and installed on mobile device 120. Offer application 124 may receive offers for products or services from service provider server 180, and present the offers to user 102.

Offer application 124, in one embodiment, receives offers automatically and/or dynamically by server push, wherein the request for transmitting offer-related information is initiated by service provider server 180. The offers may be presented to user 102 by a notification, such as by an offer prompt screen being displayed on mobile device 120. A notification sound or vibration may accompany the offer prompt screen. In another embodiment, offers are received and/or downloaded when user 102 opens offer application 124. An offer may be presented to user 102 when user 102 opens offer application 124 and selects the offer from a list of one or more offers.

Mobile device 120, in various embodiments, may include other applications 126 as may be desired in one or more embodiments of the present disclosure to provide additional features available to user 102. In one example, such other applications 126 may include security applications for implementing client-side security features, programmatic client applications for interfacing with appropriate application programming interfaces (APIs) over network 160, and/or various other types of generally known programs and/or software applications. In still other examples, other applications 126 may interface with user interface application 122 for improved efficiency and convenience.

Mobile device 120, in one embodiment, may include at least one user identifier 128, which may be implemented, for example, as operating system registry entries, cookies associated with user interface application 122, identifiers associated with hardware of mobile device 120, or various other appropriate identifiers. User identifier 128 may include one or more attributes related to user 102, such as personal information related to user 102 (e.g., one or more user names, passwords, photograph images, biometric IDs, addresses, phone numbers, social security number, etc.), banking information, and/or funding sources (e.g., one or more banking institutions, credit card issuers, user account numbers, security data and information, etc.). In various implementations, user identifier 128 may be passed with a user login request to service provider server 180 via network 160, and user identifier 128 may be used by service provider server 180 to associate user 102 with a particular user account maintained by service provider server 180.

In various implementations, user 102 is able to input data and information into an input component (e.g., a touchscreen, a keyboard, a microphone, etc.) of mobile device 120 to provide personal metric information and other user information. The user information may include user identification information.

Mobile device 120, in various embodiments, include a location component 140 configured to determine, track, monitor, and/or provide an instant geographical location of mobile device 120. In one implementation, the geographical location may include GPS coordinates, zip-code information, area-code information, street address information, and/or various other generally known types of location information. In one example, the location information may be directly entered into mobile device 120 by user 102 via a user input component, such as a keyboard, touch display, and/or voice recognition microphone. In another example, the location information may be automatically obtained and/or provided by the mobile device 120 via an internal or external monitoring component that utilizes a global positioning system (GPS), which uses satellite-based positioning, and/or assisted GPS (A-GPS), which uses cell tower information to improve reliability and accuracy of GPS-based positioning. In other embodiments, the location information may be automatically obtained without the use of GPS. In some instances, cell signals or wireless signals are used. For example, location information may be obtained by checking in using mobile device 120 via a check-in device at a location, such as a beacon. This helps to save battery life and to allow for better indoor location where GPS typically does not work.

Wearable device 150, in various embodiments, is utilized by user 102 to interact with mobile device 120 by local wireless communications, such as Bluetooth low energy (i.e., Bluetooth Smart®), wireless local area network (WLAN), Wi-Fi, near field communications (NFC), etc., or by wired communications, such as by a wired Universal Serial Bus (USB) connection. Wearable device 150 transmits personal metric information to mobile device 120, for example, by wireless syncing via Bluetooth Smart®. Mobile device 120 in turn transmits personal metric information to personal metric information server 170. Wearable device 150 may communicate with personal metric information server 170, and/or service provider server 180 over network 160 via mobile device 120.

Wearable device 150, in other embodiments, is configured to communicate wirelessly over network 160. Wireless device 150 may be utilized by user 102 to interact with mobile device 120, personal metric information server 170, and/or service provider server 180 over network 160. For example, user 102 may transmit personal metric information to mobile device, 120, personal metric information server 170, and/or service provider server 180 via wearable device 150. In another example, user 102 may receive an offer from service provider server 180 via wearable device 150.

Wearable device 150, in various embodiments, may be implemented using any appropriate combination of hardware and/or software configured for wired and/or wireless communication. In various implementations, the wearable device includes at least one of an activity tracker (e.g., Flex™ from Fitbit®, UP24™ from Jawbone®, FuelBand™ by Nike®), which may also be called a fitness tracker and/or health tracker, smart watch (e.g., Galaxy Gear™ from Samsung®, Pebble Steel™ from Pebble®), eyeglasses with appropriate computer hardware resources (e.g., Google Glass™ from Google®), and/or other types of wearable computing devices.

Wearable device 150, in certain embodiments, may further include user interface application 122, offer application 124, other applications 128, user identifier 128, and/or location component 140 as described above for mobile device 120.

Mobile device 120 and/or wearable device 150, in various embodiments, include one or more sensors 142. Mobile device 120 and/or wearable device 150 may use sensors 142 to measure, which may include tracking, monitoring, detecting, quantifying, capturing, and/or otherwise measuring, one or more personal metrics. Mobile device 120 and/or wearable device 150 may receive data relating to the personal metrics, such as measurements and/or counts of the personal metrics, from sensors 142. For example, mobile device 120 and/or wearable device 150 may receive the personal metric data by accessing and/or communicating with sensors 142. Mobile device 120 and/or wearable device 150 may process, analyze, infer from, and/or interpret personal metrics data, such as raw data of sensor measurements, to generate additional personal metric information.

Sensors 142 may comprise an accelerometer, gyroscope, actimetry sensor, altimeter, pedometer, heart rate sensor, blood pressure sensor, thermometer, image sensor, thermal camera and/or microphone. The accelerometer that measures acceleration and the gyroscope that measures orientation may be used together to measure movement, such as an activity of user 102. The accelerometer may be used to measure movement while user 102 is asleep to determine sleep patterns and/or circadian rhythms. The actimetry sensor, which includes an accelerometer and is specialized for measuring movement during sleep, may also be used to determine sleep patterns and circadian rhythms. The altimeter measures altitude and may be used to measure an incline of a path traveled by user 102. The pedometer measures a number of steps taken by user 102. The heart rate sensor, blood pressure sensor, and/or thermometer measure vital signs of user 102.

In one aspect, when interfacing with mobile device 120 and/or wearable device 150, user may elect and/or consent to provide personal information, such as personal metric information and/or location information, to personal metric information server 170 and/or service provider server 180. User 102 may set or configure the user settings/configuration menu of the offer application 124, mobile device 120, and/or wearable device 150. Through the user settings/configuration menu, user 102 may provide consent to share personal information, extent of the shared personal information, offer categories of interest, neighborhoods or merchants of interest, etc. Mobile device 120 and/or wearable device 150 may transmit the shared personal information dynamically by push synchronization, periodically, or each time offer application 124 is opened by user 102. In some embodiments, user 102 may be prompted for permission to release personal information. Accordingly, user 102 may have exclusive authority to allow transmission of personal metric information and/or location information from the mobile device 120 and/or wearable device 150 to personal metric information server 170 and/or service provider server 180.

Mobile device 120 and/or wearable device 150, in many embodiments, include a database 144. Mobile device 120 and/or wearable device 150 may locally store personal metric information in database 144. The personal metric information, which is based on the personal metrics measured by sensors 142, may include personal metric data, such as raw data of sensor measurements, the personal metric data processed into information relating to personal metrics, personal metric history and trends over time, etc.

The personal metric information, in many embodiments, includes a variety of types of personal metric information. The personal metric information may include, for example, sleep-related information, vital sign-related information, activity information, etc. Each type of personal metric information may be based on one or more personal metrics. One personal metrics can be used for more than one type of personal metric information. For example, the personal metrics of heart rate may be used for sleep-related information, such as to determine whether user 102 is asleep, and also be used for activity information, such as to determine the number of calories burned.

Sleep-related information may include sleep patterns, circadian rhythms, number of hours slept, including number of hours in rapid eye movement (REM) sleep and deep sleep, and/or quality of sleep. Sleep-related information may also include trends and/or averages of each thereof. Sleep-related information may be based on measurements of movement, noise, temperature, heart rate, and/or location of user 102 (e.g., at home or hotel room) by sensors 142.

Activity information may include a number of steps taken, distance traveled by walking, jogging, running, cycling, etc., length of time exercised, and/or calories burned. Activity information may be based on measurements of a step count, incline of path of travel, hear rate, and/or location tracking.

Vital sign-related information may include measured vital signs, measured changes in vital signs, trends and averages over time, and any other information related to vital signs. The vital signs include a heart rate, breathing/respiratory rate, temperature, and blood pressure. The changes in vital signs may be measured for an event, such as when user 102 views an offer, to determine the reaction of user 102 to the event. For example, a rise in heart beat in response to an offer may be used as a proxy and/or a signal for user's excitement and/or interest in the offer. Service provider server 180 may accordingly infer from the rise in heartbeat that user 102 is interested in a category of offers and provide more offers in same or related categories.

Mobile device 120 and/or wearable device 150 may transmit personal metric information to another user device (e.g., a PC or laptop), personal metric information server 170, and/or service provider server 180. The other user device, wearable device 150, personal metric information server 170, and/or the service provider server 180 may further process, analyze, infer from, and/or interpret personal metrics information to generate additional personal metric information. The other user device, personal metric information server 170, and/or service provider server 180 can store a personal metric history that includes long-term personal metric information compiled over time, and personal metric trends and averages based on the personal metric history.

Mobile device 120, wearable device 150, personal metric information server 170, and/or service provider server 180, in one embodiment, may take into account various non-personal metric information, such as a time of day, location of user 102, schedule of user 102, calendar of user 102, etc. when generating and/or processing personal metric information. For example, a time of a day (e.g., night time) and a location (e.g., at home or at a hotel) may be used to determine and/or infer whether user 102 is asleep.

One or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of user identity information as part of offering the items to user 102 over the network 160. As such, each of the one or more merchant servers 130 may include a merchant database 132 for identifying available items, which may be made available to the mobile device 120 for viewing and purchase by user 102. In one or more embodiments, user 102 may complete a transaction such as purchasing the items via service provider server 180.

One or more merchant servers 130, in many embodiments, may maintain one or more offers in merchant database 132. In an example, the offers may be authorized and/or created by merchants, manufacturers, and service providers for their products and/or services. In another example, the offers may be negotiated between merchants and the service provider that provides offers. An offer may comprise a coupon, a voucher deal, or any other offer for a product and/or service.

A coupon usually does not require a purchase, and may be an electronic ticket delivered to mobile device 120 and/or wearable device 150 that can be exchanged for a financial discount or a rebate when purchasing a product or service. The coupon may be referred to as a coupon code, promotional code, promotion code, discount code, key code, surplus code, portable code, shopping code, reward code, referral code source code, etc.

A voucher deal (e.g., Groupon® deals) typically requires a purchase of a voucher for a product and/or service at a discounted price, and may be an electronic ticket or document delivered to mobile device 120 and/or wearable device 150 that can be exchanged for the product and/or service at a merchant location. The voucher deal may be referred to as a discount gift certificate, discount voucher, voucher code, deal of the day, daily deal, daily deal voucher, etc.

Each of the merchant servers 130, in one embodiment, may include a marketplace application 134, which may be configured to provide information over the network 160 to user interface application 122 of the mobile device 120. For example, user 102 may interact with marketplace application 134 through user interface application 122 over network 160 to search and view various items available for purchase in merchant database 132.

Each of the merchant servers 130, in one embodiment, may include at least one merchant identifier 136, which may be included as part of the one or more items made available for purchase so that, e.g., particular items are associated with particular merchants. In one implementation, merchant identifier 136 may include one or more attributes and/or parameters related to the merchant, such as business and banking information. In various embodiments, user 102 may conduct transactions (e.g., searching, selection, monitoring, purchasing, and/or providing payment for items) with each merchant server 130 via service provider server 180 over network 160.

Personal metric information server 170, in one embodiment, may be maintained by a business entity that produces wearable device 150 (e.g., Fitbit®, Pebble®, Nike®, Samsung®, etc.), a partner of that business entity, and/or by an online service provider. Personal metric information server 170 maintains one or more accounts in an account database 174, each of which may include account information 176 associated with an individual users (e.g., user 102) and/or an individual wearable device (e.g., wearable device 150). For example, account information 194 may include personal metric information, such as personal metric data measured by sensors 142 on wearable device 150. Personal metric information server 170 may communicate personal metric information with mobile device 120, wearable device 150, and/or service provider server 180.

Personal metric information server 170, in one embodiment, includes a wearable device application 172. Wearable device application provides an interface in which user 102 may view personal metric information, track trends, and/or process information. For example, user 102 may be able to access wearable device application 172 through a website maintained by personal metric information server 170.

Service provider server 180, in various embodiments, may be maintained by a service provider that provides offers, online services, and/or processing for financial transactions and/or information transactions between user 102 and merchant servers 130. As such, service provider server 180 includes a service application 182, which may be adapted to interact with the mobile device 120 and/or each merchant server 130 over the network 160 to facilitate the searching, selection, purchase, and/or payment of items by user 102 from one or more of the merchant servers 130. In one example, service provider server 180 may be provided by a payment service provider such as PayPal®, Inc. (an eBay® company) of San Jose, Calif., USA, and/or one or more financial institutions or a respective intermediary that may provide multiple point of sale devices at various locations to facilitate transaction routings between merchants and, for example, financial institutions.

Service provider server 180, in an embodiment receives personal metric information and/or location information from mobile device 120, wearable device 150, and/or personal metric information server 170. In certain embodiments, service provider 170 directly receives the personal metric information from mobile device 120 and/or wearable device 150 over network 160. In other embodiments, service provider 180 receives the personal metric information via an intermediary such as personal metric information server 170 because, for example, wearable device 150 does not have connectivity to network 160 and/or the wearable device company that produces wearable device 150 does not makes the data and/or information accessible to third parties. In some embodiments, service provider server 180 receives the personal metric information by accessing and/or retrieving the personal metric information on mobile device 120, wearable device 150, and/or personal metric information server 170.

Service provider server 180, in many embodiments, maintains one or more offers for products and/or services at various merchants in a database 192. Service provider server 180 receives the offers from merchant servers 130, and maintains the offers in database 192, keeping the offers updated and ready for presenting to users. For example, merchant servers 130 may periodically send offers to service provider server 180 so that the service provider can present the offers to user 102. In another example, service provider server 180 may access the offers on merchant database 132. In some embodiments, service provider server 180 automatically syncs the offers information in real-time. Offers may also be created and/or authorized by the service provider so that user 102 pays a discount price and the service provider pays the difference between the full price and the discounted price.

Service provider server 180, in one embodiment, may be configured to maintain one or more user accounts in database 192, each of which may include account information 194 associated with one or more individual users (e.g., user 102). Account information 194 may include personal metric information and/or location information. Account information 194 may also include private financial information of user 102, such as one or more account numbers, passwords, credit card information, banking information, or other types of financial information, which may be used to facilitate financial transactions between user 102 and one or more merchants associated with merchant servers 230. In various aspects, the methods and systems described herein may be modified to accommodate users and/or merchants that may or may not be associated with at least one existing user account and/or merchant account, respectively.

Service application 182, in one embodiment, utilizes an offer application 184 to access offers received from merchant servers 130 and select offers to present to user 102 based on personal metric information. In one implementation, the selection of offers is based on criteria for each offer. Offer application 184 determines whether criteria for an offer are satisfied by taking personal metric information as input. Offer application 184 may determine that criteria for an offer are satisfied based on personal metric information and further based on other information, such as location information, a time of day, schedule of user 102, calendar of user 102, etc. One or more of the criteria may be open ended, such that the criterion is taken into account but not determinative. Offer application 184 may further adjust criteria for an offer such that the criteria are personalized for an individual user (e.g., user 102) based on his or her personal metric information.

Service application 182, in one embodiment, utilizes a payment processing application 186 to process purchases and/or payments for financial transactions between user 102 and merchant servers 130. In one implementation, payment processing application 186 assists with resolving financial transactions through validation, delivery, and settlement. As such, service application 182 in conjunction with the payment processing application 186 settles indebtedness between user 102 and each merchant server 130, wherein accounts may be directly and/or automatically debited and/or credited of monetary funds in a manner as accepted by the banking industry.

In one implementation, user 102 may have identity attributes stored with service provider server 180, and user 102 may have credentials to authenticate or verify identity with service provider server 180. User attributes may include personal information, banking information and/or funding sources. In various aspects, the user attributes may be passed to service provider server 180 as part of a login, search, selection, purchase, and/or payment request, and the user attributes may be utilized by service provider server 180 to associate user 102 with one or more particular user accounts maintained by the service provider server 180.

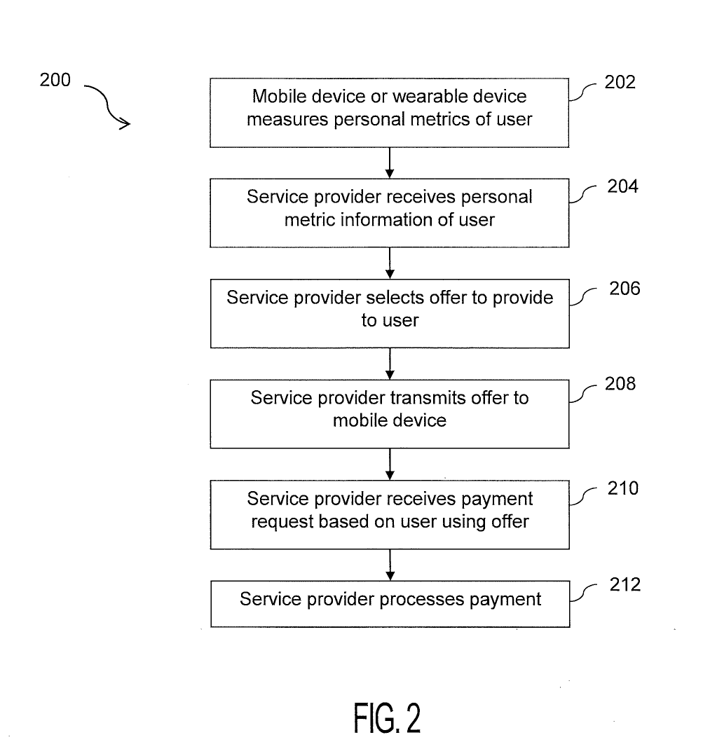

Referring now to FIG. 2, a flowchart of a method 200 for providing offers based on personal metrics is illustrated according to an embodiment of the present disclosure. At step 202, mobile device 120 or wearable device 150 measures, which may include tracking, monitoring, detecting, quantifying, capturing, and/or otherwise measuring, one or more personal metrics of a user.

At step 204, service provider server 180 receives the personal metric information of user 102. In an embodiment, service provider server 180 receives the personal metric information from mobile device 120, wearable device 150, and/or personal metric information server 170. The extent of personal metric information that is received by service provider server 180 may depend on user consent and/or election. Service provider server 180 may store the personal metric information on database 192, and may further process the personal metric information.

The personal metric information may be transmitted to service provider server 180 dynamically by automatic synchronization or periodically every predetermined time period (e.g., every 3 hours). For example, mobile device 120 and/or wearable device 150 may measure the personal metrics of user 102 and directly transmit the personal metric information to service provider server 180. In another example, mobile device 120 and/or wearable device 150 may transmit the personal metric information to personal metric information server 170, which stores and maintains the personal metric information of user 102. Service provider server 180 may in turn receive the personal metric information from personal metric information server 170.

At step 206, service provider server 180 selects an offer to provide to user 102. In an embodiment, service provider server 180 selects an offer based on the personal metric information. The service provider may select the offer further based on criteria for the offer.

In another embodiment, service provider server 180 determines that criteria for an offer are satisfied based on the personal metric information and other information, such as a location of user 102, a time of a day, etc. For example, criteria for an offer for a sports drink may include distance user 102 has run, weather, location of user 102, etc. User 102 may be provided an offer for a free sports drink if user 102 ran more than a mile, the weather is hot, and there is a merchant nearby that sells sports drinks. User 102 may be provided a discounted sports drink if user 102 ran more than a mile and the weather is cool. User 102 may be provided no offer if user 102 ran less than a mile.

In a further embodiment, service provider server 180 may determine that criteria for an offer are satisfied further based on interests of user 102 based on measured changes in vital signs in response to previous offers. Service provider server 180 may measure changes in vital signs and use it as a proxy for gauging the interest level of user 102, for example, by inferring interest and/or excitement from an increase in heart rate. Service provider server 180 may present similar and/or related offers based on such feedback.

Collecting such information and using it to provide relevant offers to user 102 is advantageous to the service provider and merchants because the offers are more likely to lead to purchases. User 102 also benefits by receiving offers that he or she is likely to be interested in and avoiding offers that he or she is likely not interested in.

In certain embodiments, service provider server 180 may determine that criteria for an offer are satisfied based on a need of user 102 for an offer. For example, service provider server 180 may determine that user 102 is driving late at night by accessing mobile device 120 and/or wearable device for a location of user 102. Service provider server 180 may further determine that user 102 is sleepy based on personal metric information, such as the number of hours slept in the previous few nights. Service provider server 180 may then determine that criteria for needing coffee has been satisfied and provide an offer for a free cup of coffee or a discounted coffee at the closest merchant. In another example, service provider server 180 may determine based on personal metric information that user 102 has run a long distance in hot weather and has dropping blood pressure. Service provider server 180 may then determine that criteria for needing a drink has been satisfied since user 102 is dehydrated, and provide an offer for a free or discounted drink.

Providing offers that user 102 needs is advantageous to typical offers because they may help prevent accidents and benefit the health of user 102. By suggesting offers for products and/or services that user 102 needs, service provider 180 reminds or motivates user 102 to seek those products and/or services, even when user 102 does not realizes he or she needs it.

In some embodiments, service provider server 180 may determine that criteria for an offer are satisfied further based on whether user 102 used or saved previous offers. Service provider server 180 may infer that user 102 is not interested in a certain product if user 102 does not use and/or save offers for the product for a predetermined number of times. For example, if user 102 does not use and/or save an offer for discounted coffee every morning for a predetermined number of days (e.g., 10 days), service provider server 180 may infer that user 102 does not drink coffee in the morning and stop presenting offers for coffee.

At step 208, service provider server 180 transmits the offer to mobile device 120 and/or wearable device 150. In an embodiment, service provider server 180 transmits the offer to mobile device 120 and/or wearable device 150 by sending information and/or data related to an electronic coupon or a voucher deal. The electronic coupon or voucher deal may comprise a barcode, such as a Universal Product Code (UPC) or a Quick Response code (QR code), and discount information for a product or service. User 102 may go to a merchant and present the barcode to the merchant for scanning to use the offer.

At step 210, the merchant sends a payment request and the payment request is received by service provider server 180. The payment request may be based on user 102 using the offer to purchase the product or service at the merchant.

At step 212, service provider server 180 processes the payment request. The offer may be applied to the purchase by the merchant and/or service provider server 180.

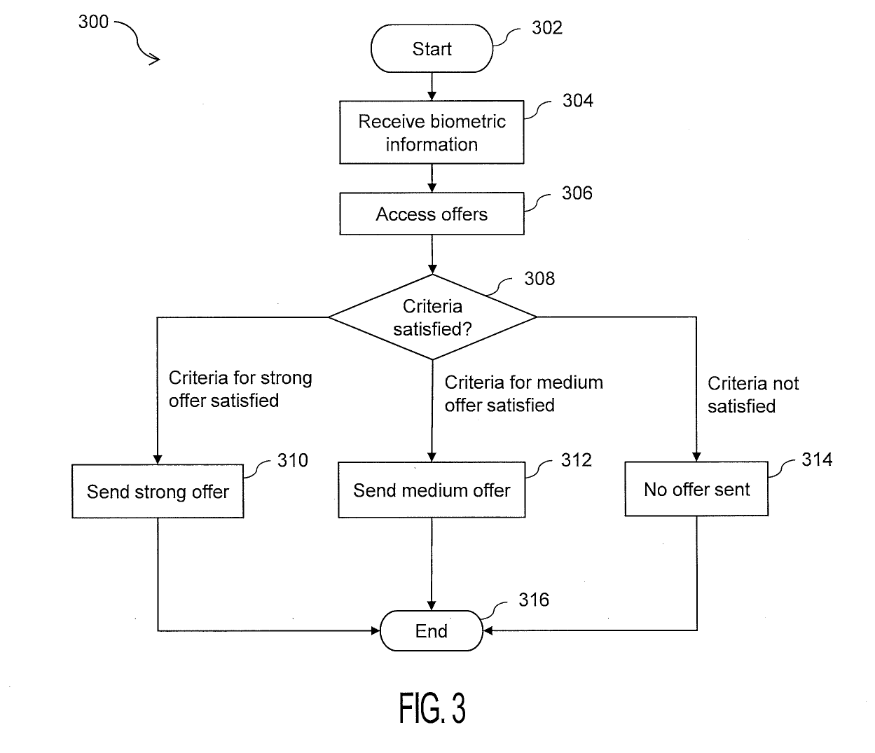

Referring now to FIG. 3, a flowchart of a method 300 for presenting offers based on criteria for an offer is illustrated according to an embodiment of the present disclosure.

At block 302, user 102 opens offer application 124 to view offers.

At block 304, service provider server 180 receives personal metric information from mobile device 120, wearable device 150, and/or personal metric information server 170. For example, service provider server 180 may receive sleep-related information, which may include personal metric data, number of hours slept, sleep patterns, sleep quality, sleep-related average, sleep-related trends over time, and/or any other sleep-related information. Mobile device 120 or wearable device 150 may measure movement, sound, vital signs, etc. and store measurements as personal metric data. The personal metric data may be processed to infer sleep patterns, number of hours slept, circadian rhythms, and/or sleep quality. The sleep patterns, number of hours slept, circadian rhythms, and/or sleep quality may be compiled and further processed for averages and trends over time.

At block 306, service provider server 180 accesses offers that are stored in database 192 to select offers based on the personal metric information. For example, service provider server 180 may access database 192 for offers with criteria that are related to sleep.

At block 308, service provider server 180 determines whether criteria for an offer are satisfied based on the personal metric information. In an embodiment, criteria for an offer includes the number of hours slept the night before. For example, service provider server 180 may present a different offer based on whether user 102 received less than 3 hours of sleep, 3 to 5 hours of sleep, or more than 5 hours of sleep.

In other embodiments, satisfaction of the criteria for an offer is further based on other information, such as a time of day or a location of user 102. For example, satisfaction of the criteria may depend on whether it is morning, evening, or night. Service provider server 180 may determine that the criteria for free or discounted coffee are satisfied only when it is morning, or before a certain time (e.g., 6 pm). If user 102 received little sleep the night before but it is 8 pm, service provider server 180 may not present the offer for free or discounted coffee. Service provider server 180 may present another offer instead, such as an offer for decaf coffee or tea.

In a further embodiment, criteria for an offer are personalized based on a user history. The user history may comprise personal metric information compiled over time (e.g., sleep history, activity/exercise history, vital signs history, etc.) and trends and averages of personal metrics over time. The user history may further comprise a purchase history, previous coupon uses, previous saved coupons, etc. For example, service provider server 180 may take into account averages and trends of metrics such as number of hours slept, sleep quality, circadian rhythm, etc., during a time period (e.g., past month). A user who usually sleeps 8 hours but slept 5 hours may be provided with a better offer than another user who also slept 5 hours but usually sleeps 5 hours. In another example, service provider 180 may take into account the typical activity level of user 102 comprising averages and trends of metrics such as number of exercise sessions per week, number of hours exercised per exercise session, jog speed, etc., during a time period (e.g., past month). A user who does not exercise regularly may receive an offer after jogging 1 mile, but another user who frequently jogs 5 miles may not receive an offer after jogging 1 mile. Thus, service provider server 180 may provide offers to reward and/or further incentivize certain activities detected by mobile device 120 or wearable device 150 based on an established baseline based on the user history.

In certain embodiments, satisfaction of criteria for an offer is further based on user preferences and/or user habits. Service provider 180 may determine user preferences and/or habits by accessing user account information comprising user history to infer user preferences and/or habits. Service provider 180 may further determine user preferences and/or habits by interacting with user 102 through mobile device 120, such as by a prompt that asks “do you prefer A or B?” or by allowing user 102 to select an offer for either A or B. Service provider 180 may determine that user 102 prefers certain products, services, brands, locations, times, etc., and provide offers based on those preferences. For example, user 102 may be offered tea instead of coffee, Powerade® instead of Gatorade®, and ice cream cone instead of fruit smoothie based on a user's preferences. Service provider 180 may determine that user 102 has a habit of purchasing certain products, services, brands, etc., at certain locations and/or times, and provide offers based on those habits. For example, service provider 180 may provide an offer for coffee in the morning based on a user's habit of drinking morning coffee. Service provider 180 may further determine that after a certain recurring event detected by mobile device 120 or wearable device 150, user 102 has a habit of purchasing a certain product or has a preference for that product. For example, service provider 180 may provide an offer for a sports drink after exercise based on a user's habit of purchasing a sports drink after exercise, which is detected by wearable device 150.

At block 310, if criteria for a strong offer are satisfied, service provider server 180 sends a strong offer to user 102. The strong offer may be for a free to deeply discounted product or service. For example, service provider server 180 may determine that criteria for a free coffee offer are satisfied when user 102 receives less than 3 hours of sleep. If user 102 received 2 hours of sleep, user 102 may be presented with the offer for free coffee.

At block 312, if criteria for a medium offer are satisfied, service provider server 180 sends a medium offer. The medium offer may be for a deeply discounted or slightly discounted product or service. For example, service provider server 180 may determine that criteria for a discounted coffee offer are satisfied when user 102 receives between 3 to 5 hours of sleep. If user 102 received 4 hours of sleep, user 102 may be presented with the offer for half-off on coffee.

At block 314, if criteria for an offer are not satisfied, service provider server 180 does not send an offer. For example, service provider server 180 may determine that criteria for free or discounted coffee offers are not satisfied when a user receives more than 5 hours of sleep.

At block 316, user 102 views the offer on mobile device 120 and/or wearable device 150 if one was sent.

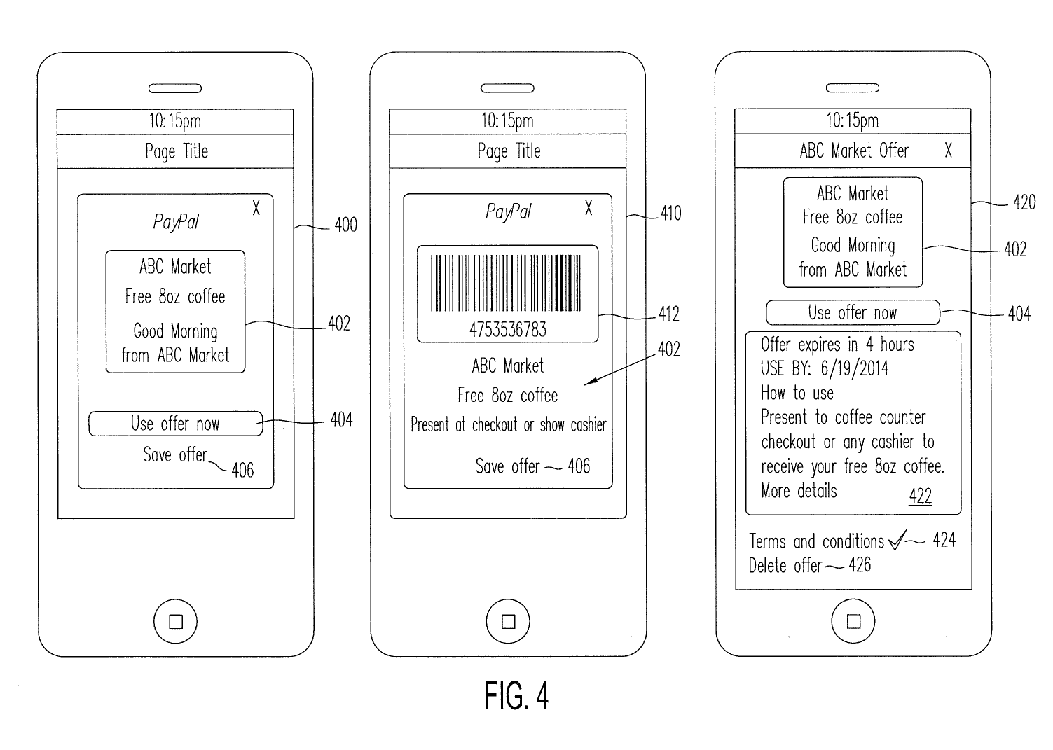

Referring now to FIG. 4, various screens presenting an offer on a mobile device are illustrated according to an embodiment of the present disclosure. In an embodiment, user 102 may be presented with an offer prompt screen 400 on mobile device 120 when service provider server 180 sends the offer to mobile device 120. In another embodiment, user 102 may open offer application 124 and select an offer from a list of offers to view offer prompt screen 400.

Offer prompt screen 400 presents the offer and may include a description of the offer 402, a “use offer” button 404, and a “save offer” link 406. Offer description 402 may include a description of the product or service that the offer is for, merchants where the offer is accept, a message or a greeting, and/or any other information related to the offer. User 102 may decide to use the offer by selecting use offer button 404, which opens up a use offer screen 410. User 102 may decide to save the offer by selecting save offer link 406, which saves the offer by, for example, putting the offer into a digital wallet associated with an account of user 102. The digital wallet may contain one or more offers that are saved by user 102 for later use. The account may be an account maintained by service provider server 180.

Use offer screen 410 is displayed when user 102 selects the use offer button 404 on the offer prompt screen 400. Use offer screen 410 may include a barcode 412, offer description 402, and save offer link 406. User 102 may present barcode 412 to a merchant for scanning to use the offer.

A saved offer screen 420 is displayed when user 102 selects a saved offer in a digital wallet of user 102. Saved offer screen 420 includes offer description 403, use offer button 404, expiration and instructions 422, a link to a terms and conditions page 424, and a delete offer link 426. Expiration and instructions 422 may include when the offer expires and/or a use by date/time, instructions on how to use the offer, and a link for more details. User 102 may select use offer button 404 to open use offer screen 410, or select the delete offer link 426 to delete the offer from the digital wallet.

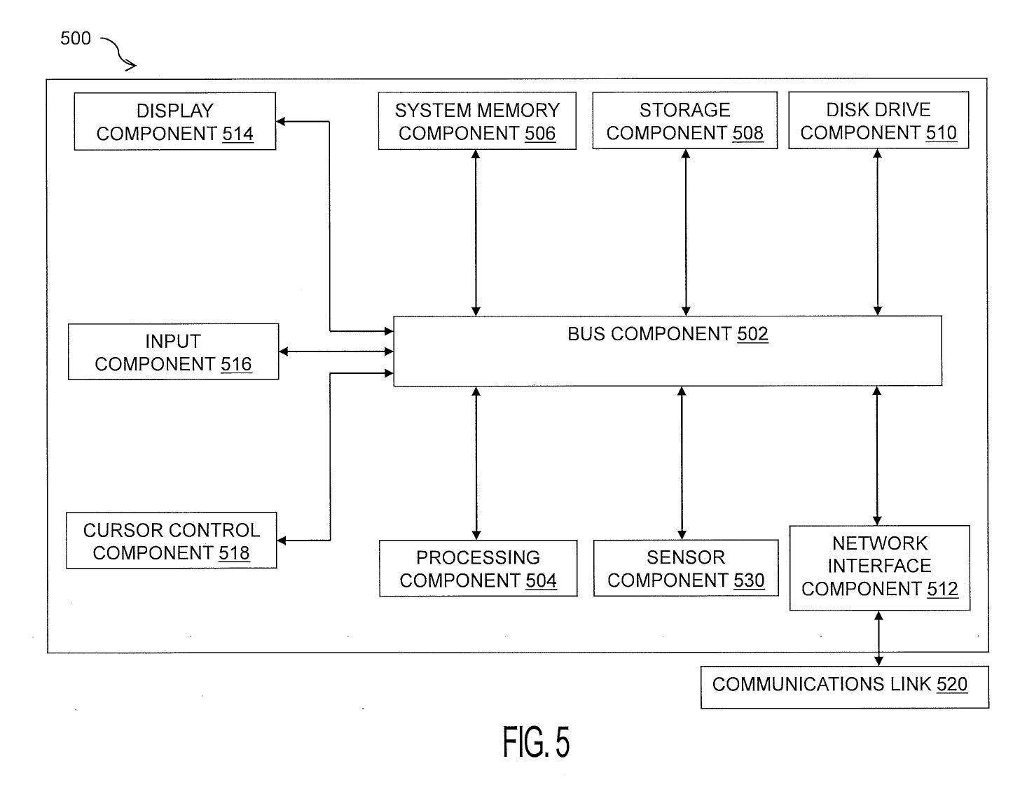

Referring now to FIG. 5, a block diagram of a system 500 is illustrated suitable for implementing embodiments of the present disclosure, including mobile device 120, one or more merchant servers or devices 130, wearable device 150, personal metric information server or device 170, and service provider server or device 180. System 500, such as part of a cell phone, a tablet, a personal computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 542, a display component 514 (or alternatively, an interface to an external display), an input component 516 (e.g., keypad or keyboard), a cursor control component 518 (e.g., a mouse pad), and a sensor component 530 (e.g., gyroscope, accelerometer, camera, pedometer, heart rate monitor, etc.).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to access personal metric data on one or more sensors of the mobile device, process personal metric data, select an offer based on personal metric information and/or criteria for the offer, present the offer on a display of a mobile device, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching, auto-synchronizing, storing access control information, making payments, or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., network 160 of FIG. 1, LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

In view of the present disclosure, it will be appreciated that various methods and systems have been described according to one or more embodiments for presenting offers based on personal metrics.

Although various components and steps have been described herein as being associated with mobile device 120, one or more merchant servers or devices 130, wearable device 150, personal metric information server or device 170, and service provider server or device 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data may be stored on one or more computer readable mediums. It is also contemplated that software identified herein may be implemented using one or more specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, mobile device, server, and other devices described herein.

What is claimed is:

1. A system, comprising:
a memory device storing personal metric information; and
one or more processors in communication with the memory device and configured to:
receive the personal metric information of a user;
select an offer based on the personal metric information; and
transmit the offer to a mobile device or a wearable device.

2. The system of claim 1, wherein the personal metric information is based on one or more personal metrics of the user measured by sensors on the mobile device or the wearable device.

3. The system of claim 2, wherein the one or more processors are further configured to receive the personal metric information from the mobile device, the wearable device, or a personal metric information server.

4. The system of claim 1, wherein the one or more processors are configured to select the offer further based on a location of the user, a time of a day, a user preference, a user habit, a user history, or a combination thereof.

5. The system of claim 1, wherein the personal metric information comprises a sleep pattern, hours slept, sleep quality, or a combination thereof.

6. The system of claim 1, wherein the personal metric information comprises a distance traveled, steps taken, calories burned, or a combination thereof.

7. The system of claim 1, wherein the personal metric information comprises measured vital signs, measured changes in vital signs in response to previous offers, or both.

8. The system of claim 1, wherein the one or more processors are further configured to:
determine interests of the user based on changes in heart rate in response to previous offers; and
select the offer further based on the interests of the user.

9. The system of claim 1, wherein the one or more processors are configured to transmit the offer to the mobile device or the wearable device by sending information related to an electronic coupon comprising a barcode.

10. The system of claim 1, wherein the one or more processors are further configured to:
receive a payment request from a merchant, wherein the payment request is based on the user using the offer for a purchase at the merchant; and
process the payment request.

11. A method for presenting an offer to a user, comprising:
receiving, by one or more processors, personal metric information of the user;
determining, by one or more processors, that one or more criteria for the offer are satisfied based on the personal metric information; and
presenting, by the one or more processors, the offer on a mobile device.

12. The method of claim 11, wherein the personal metric information is based on one or more personal metrics measured by sensors on the mobile device or a wearable device.

13. The method of claim 12, wherein the receiving of the personal metric information comprises accessing the mobile device, the wearable device, or a personal metric information server.

14. The method of claim 11, wherein the determining that the one or more criteria for the offer are satisfied is further based on a user preference, a user habit, a user history, or a combination thereof.

15. The method of claim 11, wherein the personal metric information includes sleep-related information, vital sign-related information, activity information, or a combination thereof.

16. The method of claim 15, wherein the personal metric information further includes trends over time, averages over time, or both.

17. The method of claim 11, wherein the personal metric information comprises measured changes in vital signs in response to previous offers, and wherein the method further comprises:
determining, by the one or more processors, interests of the user based on the measured changes in vital signs; and
determining, by the one or more processors, that the one or more criteria for the offer are satisfied further based on the interests of the user.

18. The method of claim 11, further comprising:
providing, by the one or more processors, the offer on the mobile device by sending data related to an electronic coupon or voucher deal to the mobile device;
receiving, by the one or more processors, a payment request from a merchant, wherein the payment request is based on the user using the offer for a purchase at the merchant; and
processing, by the one or more processors, the payment request.

19. A non-transitory machine-readable medium comprising a plurality of machine-readable instructions which, when executed by one or more processors, are adapted to cause the one or more processors to perform a method comprising:
receiving personal metric information of a user;
determining that one or more criteria for an offer are satisfied based on the personal metric information; and
transmitting the offer to a mobile device based on the one or more criteria being satisfied.

20. The non-transitory machine-readable medium of claim 19, wherein the determining that the one or more criteria for the offer are satisfied is further based on a user history comprising a compiled personal metric information over time, trends over time, averages over time, purchase history, previous offer usage, or a combination thereof.
